(19) United States
(12) Patent Application Publication
(10) Pub. No.: US 2010/0208492 A1
(43) Pub. Date: Aug. 19, 2010

(54) ILLUMINATING APPARATUS AND METHOD FOR MANUFACTURING ILLUMINATING APPARATUS

(75) Inventors: Yoshihiro Sugie, Tochigi (JP); Hitoshi Shimizu, Tochigi (JP)

Correspondence Address: KRATZ, QUINTOS & HANSON, LLP, 1420 K Street, N.W., 4th Floor, WASHINGTON, DC, 20005, US

(73) Assignees: SEIKO PRECISION INC.,, Narashino-shi (JP); INTERNIX INCORPORATED, Tokyo (JP); SHIANYIH ELECTRONIC INDUSTRY CO., LTD., Taichung City (TW)

(21) Appl. No.: 12/771,303

(22) Filed: Apr. 30, 2010

Related U.S. Application Data
(63) Continuation of application No. PCT/JP2008/069095, filed on Oct. 22, 2008.

(30) Foreign Application Priority Data
Nov. 22, 2007 (JP) 2007-303767
Mar. 11, 2008 (JP) 2008-061793

(51) Int. Cl. F21V 7/04; H01J 9/24

(52) U.S. Cl. 362/606; 362/611; 362/613; 445/23

(57) ABSTRACT

An illuminating apparatus includes: a light source; and a light guide plate guiding a light of the light source. The light source and the light guide plate are fixed to each other to be receded from a region to which the light is emitted from a light emitting surface of the light source and which is opposite to an emitting surface of the light guide plate.

### CROSS-REFERENCE TO RELATED APPLICATION

This application is a continuation of and claims priority to International Patent Application No. PCT/JP2008/069095 filed on Oct. 22, 2008, which claims priority to Japanese Patent Application No. 2008-061793 filed on Mar. 11, 2008, and Japanese Patent Application No. 2007-303767 filed on Nov. 22, 2007, subject matter of these patent documents is incorporated by reference herein in its entirety.

### BACKGROUND OF THE INVENTION

1. Field of the Invention

The present invention relates to illuminating apparatuses and methods for manufacturing the illuminating apparatus.

2. Description of the Related Art

Conventionally, there have been known an illuminating apparatus employed as a backlight of a liquid crystal display device or the like. Such an illuminating apparatus includes: a FPC (Flexible Printed Circuit); a LED (Light Emitting Diode) mounted on the FPC; and a light guide plate into which light enters from the LED. The light guide plate is arranged at a light emitting surface side of the LED (see Japanese Unexamined Patent Application Publication No. 2007-73399).

However, in the conventional illuminating apparatus, the FPC extends to reach the light emitting side of the light emitting surface of the LED, and the light guide plate is fixed on this extending portion of the FPC with a double-faced tape or an adhesive bond. Also, even if the FPC does not extend to reach the light emitting side of the light emitting surface of the LED, and the light guide plate is directly fixed to the light emitting surface of the LED with an adhesive bond, in some cases.

In these cases, the light emitted from the LED is leaked outwardly from a region opposite to an emitting surface of the light guide plate, that is, from its rear surface opposite to the emitting surface through a double-faced tape or an adhesive bond. This reduces light quantity.

In this way, when the light guide plate and the FPC are fixed or the light guide plate and the LED are fixed at the region, in which the light is emitted from the light emitting surface of the LED, and which is opposite to the emitting surface of the light guide plate, the light emitted from the light guide plate may lose its brightness due to the influence of the double-faced tape or the adhesive bond, or may lose its uniform brightness.

### SUMMARY OF THE INVENTION

It is therefore an object of the present invention to provide an illuminating apparatus and a method for manufacturing the same in which the lack of its brightness is prevented and in which its brightness is uniformly kept.

According to an aspect of the present invention, there is provided an illuminating apparatus including:

a light source; and a light guide plate guiding a light of the light source. The light source and the light guide plate are fixed to each other to be receded from a region which is a light emitting side of a light emitting surface of the light source and which is opposite to an emitting surface of the light guide plate.

### BRIEF DESCRIPTION OF THE DRAWINGS

Preferred embodiments of the present invention will be described in detail with reference to the following drawings, wherein:

FIG. 1A is a front view of an illuminating apparatus according to a first embodiment, FIG. 1B is an enlarged view of the illuminating apparatus according to the first embodiment, and FIG. 10 is a cross-sectional view of the illuminating apparatus according to the first embodiment taken along a line A-A;

FIG. 2A is a front view of a conventional illuminating apparatus, FIG. 2B is an enlarged view of the conventional illuminating apparatus, and FIG. 2C is a cross-sectional view of the conventional illuminating apparatus taken along a line B-B;

FIG. 3A is a front view of a light guide plate, FIG. 3B is a front view of a FPC with LEDs mounted thereon, and FIG. 3C is a front view of a double-faced tape;

FIG. 4A is a front view of an illuminating apparatus according to a second embodiment, FIG. 4B is an enlarged view of the illuminating apparatus according to the second embodiment, and FIG. 4C is a cross-sectional view of the illuminating apparatus taken along a line C-C;

FIG. 5A is a partially enlarged perspective view of the FPC with the LED mounted thereon, FIG. 5B is a partially enlarged perspective view of a state where the light guide plate is temporarily fixed to the LED, and FIG. 5C is a partially enlarged perspective view of a state where the boundary between the LED and the light guide plate is sealed;

FIG. 6A is a cross-sectional view of an illuminating apparatus according to a third embodiment, and FIG. 6B is a partially enlarged perspective view of a state in which a reflective sheet is struck on an upper surface of the LED; and

FIG. 7 is a cross-sectional view of an illuminating apparatus according to a fourth embodiment.

### DESCRIPTION OF THE PREFERRED EMBODIMENTS

A description will be given of embodiments of an illuminating apparatus according to the present invention with reference to the drawings.

### First Embodiment

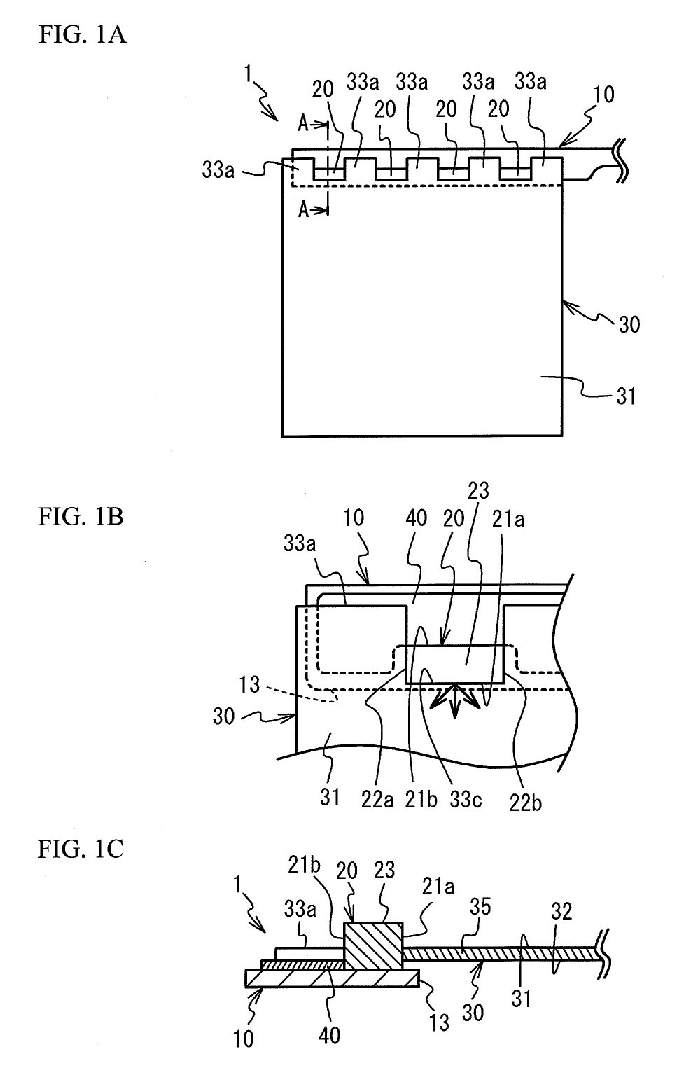

FIG. 1A is a front view of an illuminating apparatus 1 according to a first embodiment. FIG. 1B is an enlarged view of the illuminating apparatus 1 according to the first embodiment. FIG. 1C is a cross-sectional view of the illuminating apparatus 1 according to the first embodiment taken along a line A-A. As illustrated in FIG. 1A, the illuminating apparatus 1 includes: a FPC 10; plural LEDs 20 mounted on the FPC 10; and a light guide plate 30 to which the light is emitted from the LEDs 20.

The FPC 10 has a flexibility and an elongated shape, and is provided with four LEDs 20 mounted thereon at regular intervals. The FPC 10 has patterns electrically connected to the LEDs 20 mounted thereon.

The LED 20 is electrically connected to the patterns formed on the FPC 10 with, for example, a solder, and emits light from an emitting surface 21a which is a side surface perpendicular to a mounting surface of the FPC 10. The LED 20 has a rectangular parallelepiped shape, and is in contact with one side surface of the light guide plate 30. Additionally, the LED 20 has: the emitting surface 21a serving as a light emitting surface from which the light is emitted; a rear surface 21b opposite to the emitting surface 21a; side surfaces 22a and 22b perpendicular to the emitting surface 21a and the rear surface 21b; and an upper surface 23 parallel to the FPC 10.

The light guide plate 30 is made of resin such as acrylic, polyethylene terephthalate, and polycarbonate, with a thin film shape. The light guide plate 30 guides the light emitted from the LED 20 at the inside thereof and an emitting surface 31 emits the light in the whole surface.

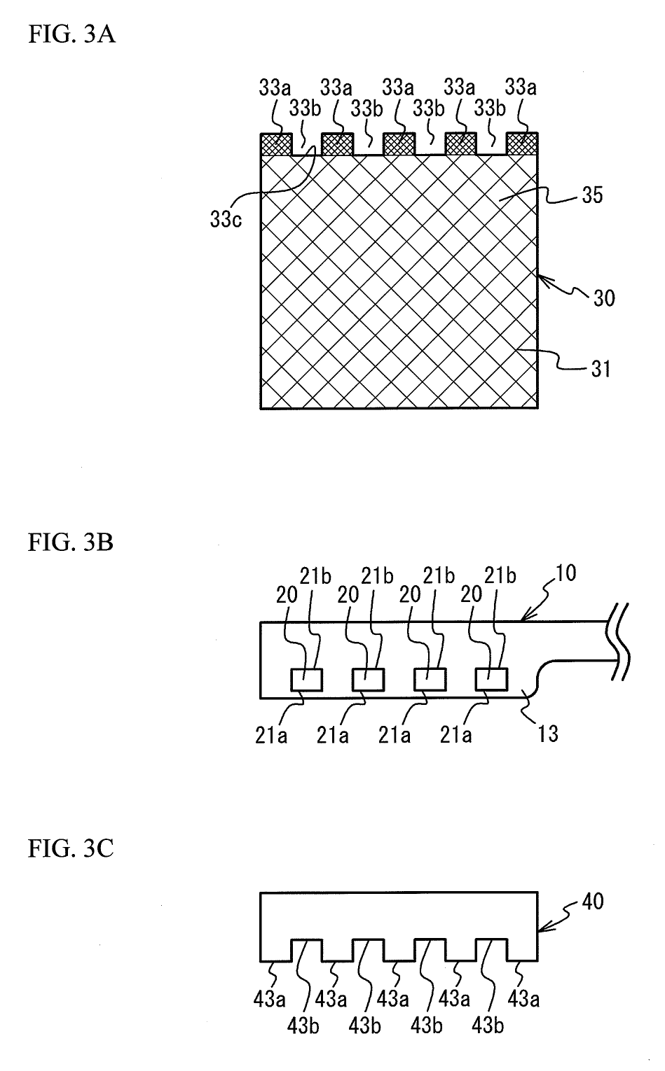

As illustrated in FIG. 3A, the light guide plate 30 has a projection portion 33a functioning as a fixing portion and a light guide portion 35 functioning to guide the light of the LED 20. The light guide portion 35 is arranged to face a light emitting side of the emitting surface 21a of the LED 20. The projection portion 33a is fixed to the FPC 10 or the LED 20 at a side opposite to the light emitting side of the emitting surface 21a.

In addition, the light guide plate 30 has one side, which is in contact with the LED 20, and which has the projection portion 33a and a depression portion 33b alternately, the projection portion 33a projecting in the planar direction of the light guide plate 30, the depression portion 33b accommodating the LED 20 and being depressed in the planar direction. The depression portion 33b has a bottom surface 33c in contact with the emitting surface 21a of the LED 20, and the bottom surface 33c functions as one side surface of the light guide portion 35. The projection portion 33a is arranged between the LEDs 20, and overlaps the FPC 10. In this manner, in the light guide plate 30, one side in contact with the LED 20 is formed to have projections and depressions.

Each of the LEDs 20 is in contact with the depression portion 33b. Specifically, the bottom surface 33c of the depression portion 33b is arranged to face the light emitting side of the emitting surface 21a of the LED 20. In other words, the light guide portion 35 is arranged to face the light emitting side of the emitting surface 21a of the LED 20, and the emitting surface 21a and the bottom surface 33c are in contact with each other. Therefore, the light emitted from the emitting surface 21a enters into the light guide plate 30, as illustrated in FIG. 1B. An arrow represents the light emitted from the emitting surface 21a in FIG. 1B. The light entered into the light guide plate 30 emits from the emitting surface 31. In this way, an entrance surface of the light guide plate 30, into which the light enters, is perpendicular to the emitting surface 31. The illuminating apparatus 1 is used as, for example, a backlight of a liquid crystal panel employed in a mobile phone or the like.

As illustrated in FIGS. 1B and 1C, the LEDs 20 are mounted on the inner side of the FPC 10 slightly apart from an edge portion 13 thereof. Further, the LED 20 is mounted such that the emitting surface 21a faces outward of the FPC 10. Furthermore, the double-faced tape 40 is interposed between the portion where the FPC 10 and the light guide plate 30 are overlapped with each other. Specifically, the double-faced tape 40 is presented between the FPC 10 and the projection portion 33a, serving as the fixing portion, of the light guide plate 30 to secure the FPC 10 to the light guide plate 30. The double-faced tape 40 is made of, for example, a metallic sheet, such as aluminum, silver, having double sides applied with adhesive bonds. However, the double-faced tape 40 is not limited to this configuration. For example, it may be a type in which double sides of sheets of paper or plastic films as a base material are applied with adhesive bonds, or it may be a type in which a base material is not provided.

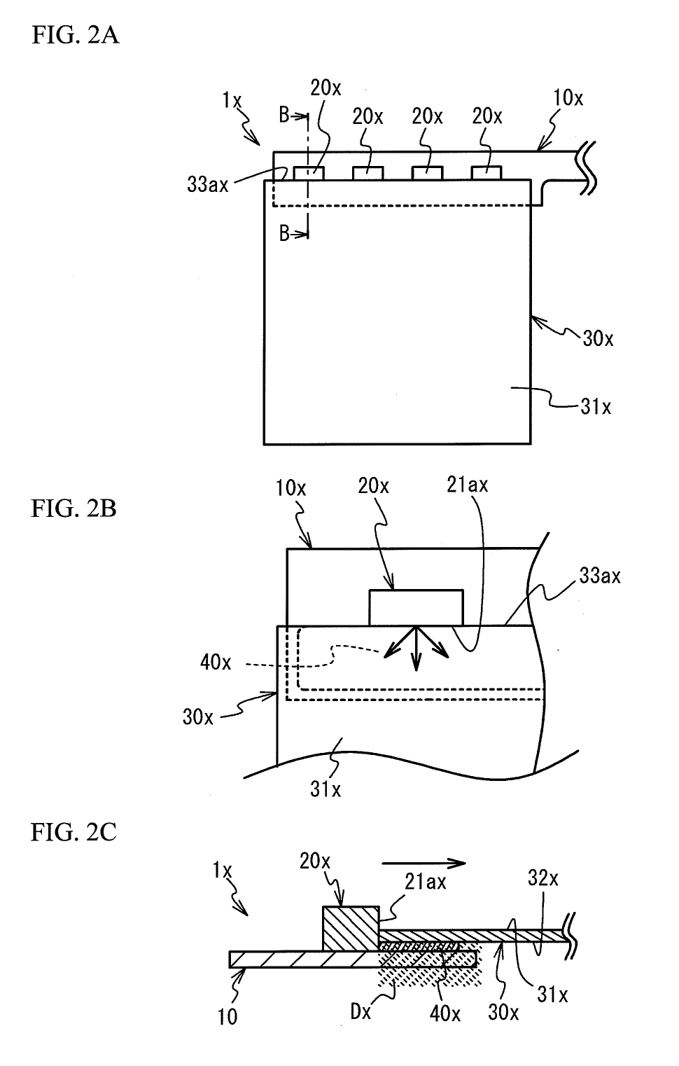

Herein, a conventional illuminating apparatus 1x will be described. FIGS. 2A to 2C are explanatory views of the conventional illuminating apparatus 1x. In addition, in the conventional illuminating apparatus 1x, similar components of the illuminating apparatus 1 are applied to similar reference numerals to omit duplication of description. FIG. 2A is a front view of the conventional illuminating apparatus 1x. FIG. 2B is an enlarged view of the conventional illuminating apparatus 1x. FIG. 2C is a cross-sectional view of the conventional illuminating apparatus 1x taken along a line B-B.

As illustrated in FIG. 2A, a projection portion 33ax of a light guide plate 30x is formed into a linear shape. Further, LEDs 20x mounted on a FPC 10x are in contact with the projection portion 33ax. Moreover, an emitting surface 21ax is in contact with the projection portion 33ax, which is arranged to face a light emitting side of the emitting surface 21ax, as illustrated in FIG. 2B. Additionally, referring to FIGS. 2B and 2C, the LEDs 20x are mounted at or near the center of the FPC 10x in the light emitting direction of the emitting surface 21ax such that the light emitting directions, perpendicular to the longitudinal direction of the FPC 10x, are aligned side by side. Further, a double-faced tape 40x is interposed between the FPC 10x and the light guide plate 30x, where they are overlapped with each other, and fixes the FPC 10x and the light guide plate 30x.

Herein, as illustrated in FIGS. 2B and 2C, the LEDs 20x are arranged around the center of the FPC 10. This means that the FPC 10x projects to the light emitting side of the emitting surface 21ax. Further, the double-faced tape 40x is interposed between the FPC 10x and the light guide plate 30x, where they are overlapped with each other, so the FPC 10a and the light guide plate 30x are fixed at the overlapped portion. That is, the FPC 10x and the fixing portion of the light guide plate 30x are located at the light emitting side of the emitting surface 21ax serving as the light emitting surface. With such a configuration, in the conventional illuminating apparatus 1x, the double-faced tape 40x influences the entering light emitted from the emitting surface 21ax, so that the emitted light, which is emitted from the emitting surface 31x of the light guide plate 30x, may lack its brightness, or so that it may be difficult to uniform the brightness. Specifically, the entering light emitted from the emitting surface 21ax of the LED 20x is leaked outwardly from the rear surface 32x opposite to the emitting surface 31x of the light guide plate 30x through the double-faced tape 40x. As a result, the light quantity is reduced to lack its brightness. Further, the light is diffusely reflected within the light guide plate 30x by the double-faced tape 40x, and thus the brightness of the emitting surface 31x may be made nonuniform. For example, when the double-faced tape 40x is made of a material having a high degree of reflection, the brightness of the emitting surface 31x in the vicinity of the double-faced tape 40x may be higher than that of any other portion.

Additionally, even if the FPC 10x and the light guide plate 30x are fixed by, for example, a pin without using the double-faced tape 40x at a projection portion of the FPC 10x to which the light is emitted from the emitting surface 21ax, the entering light emitted from the emitting surface 21ax is reflected at the projection position of the FPC 10x, whereby the brightness of the emitting surface 31x may become nonuniform like the above case.

Further, when the LED 20x and the light guide plate 30x are directly fixed by an adhesive bond at a region Dx which is opposite to the emitting surface 31x of the light guide plate 30x, the entering light emitted from the emitting surface 21ax of the LED 20x is leaked outwardly from the rear surface 32x of the light guide plate 30x through the adhesive bond. As a result, the light quantity is reduced to lack its brightness. Furthermore, the light is diffusely reflected within the light guide plate 30x by the adhesive bond, and thus the brightness of the emitting surface 31x may become nonuniform.

However, in the illuminating apparatus 1 according to the present embodiment, the LEDs 20 are mounted on the inner side of the FPC 10 slightly apart from the edge portion 13 such that their light emitting directions, perpendicular to the longitudinal direction of the FPC 10x, are aligned, as illustrated in FIGS. 1A and 1B. Herein, the FPC 10 projects to the light emitting side of the emitting surface 21a, whereas the FPC 10 and the light guide plate 30 are not fixed at the light emitting side of the emitting surface 21a. Therefore, an air layer is generated between the FPC 10 and the light guide plate 30 to prevent the light from being leaked to the FPC 10 from the light guide plate 30. Further, the light guide portion 35 of the light guide plate 30 is arranged to face the light emitting side of the emitting surface 21a of the LED 20, and is in contact with the emitting surface 21a. Furthermore, the projection portion 33a serving as the fixing portion is fixed to the FPC 10 at the side opposite to the light emitting side of the emitting surface 21a.

Herein, the double-faced tape 40 is interposed between the projection portion 33a serving as the fixing portion and the FPC 10. Specifically, the double-faced tape 40 fixes the projection portion 33a to the FPC 10 at the side surfaces 22a and 22b side, that is, at the side opposite to the light emitting side of the emitting surface 21a. Therefore, the double-faced tape 40 is not present at the light emitting side of the emitting surface 21a. Thus, neither the FPC 10 nor the double-faced tape 40 influences the entering light which enters into the light guide plate 30 from the emitting surface 21a. This prevents the lack of the brightness of the emitting surface 31 of the light guide plate 30, and uniforms its brightness.

Further, since both of the FPC 10 and the light guide plate 30 are fixed by the double-faced tape 40, the FPC 10, the LED 20, and the light guide plate 30 can be integrated. Thus, the light emitting direction of the LED 20 can be suppressed from being deviated with respect to the light guide plate 30. This also uniforms the brightness of the emitting surface 31.

Furthermore, the side, of the light guide plate 30, opposite to the LED 20, has the projection portion 33a and the depression portion 33b, which accommodate the LED 20, and which are alternately formed, as illustrated in FIGS. 1A and 1B. The projection portion 33a and the depression portion 33b are shaped to correspond to the outer shape of the LED 20. Specifically, each length of the emitting surface 21a and the rear surface 21b corresponds to a length of the bottom surface 33c of the depression portion 33b in the longitudinal direction of the FPC 10. Further, the distance between the adjacent LEDs 20 corresponds to a length of the projection portion 33a in the longitudinal direction of the FPC 10. Therefore, the bottom surface 33c of the depression portion 33b of the light guide plate 30 is arranged to face the light emitting side of the emitting surface 21a of the LED 20, so that the position of the light guide plate 30 is defined with respect to the LED 20. Thus, the projection portion 33a and the depression portion 33b serve as an alignment portion defining the position of the light guide plate 30 with respect to the LED 20. This prevents the light emitting direction of the LED 20 from being deviated with respect to the light guide plate 30 and uniforms the brightness of the emitting surface 31.

Further, in the projection and depression portion of the light guide plate 30, a length of a liner portion of an edge portion is short. This suppresses the occurrence of a burr on a surface, facing the emitting surface 21a, of the bottom surface 33c of the depression portion 33b, the bottom surface 33c being the entrance surface of the light guide plate 30, in a process for forming the light guide plate. This obtains the surface with fine accuracy. Accordingly, when the depression portion 33b of the light guide plate 30 faces the emitting surface 21a of the LED 20, the entrance of the light into the light guide plate 30 is not interfered.

Next, a description will be given of a method for manufacturing the illuminating apparatus 1 according to the present embodiment. FIG. 3A is a front view of the light guide plate 30. FIG. 3B is a front view of the FPC 10 with the LEDs 20 mounted thereon. FIG. 3C is a front view of the double-faced tape 40.

First, as illustrated in FIG. 3B, the plural LEDs 20 are mounted at the inner side of the FPC 10 slightly apart from the edge portion 13 of the FPC 10 at given regular intervals such that the light emitting directions of the LEDs 20, perpendicular to the longitudinal direction of the FPC 10, are aligned side by side. Moreover, in this case, the LEDs 20 are mounted on the FPC such that a distance between the emitting surface 21a side and the edge portion 13 is smaller.

Next, one side of the double-faced tape 40 is made to have a projection and depression shape so as to avoid interfering with the LED 20. The double-faced tape 40 formed in this manner is stuck on the mounding surface of the FPC 10 such that a depression portion 43b faces the rear surface 21b and a projection portion 43a is arranged between the emitting surfaces 21a, so that the double-faced tape 40 avoids interfering with the LED 20. In this manner, the shape of the double-faced tape 40 is made to correspond to a shape of an area, where the LEDs 20 are not mounted, of the mounting surface of the FPC 10. This results in a situation that the double-faced tape 40 is not present at the light emitting side of the emitting surface 21a of the LED 20. That is, the double-faced tape 40 is stuck at the opposite to side of the light emitting side of the emitting surface 21a, not at the light emitting side of the emitting surface 21a.

Next, the light guide plate 30 is attached to the FPC 10 stuck with the double-faced tape 40 such that the depression portion 33b of the light guide plate 30 faces the emitting surface 21a and the projection portion 33a, serving as the fixing portion, of the light guide plate 30 is arranged between the LEDs 20. That is, the emitting surface 21a faces the light guide portion 35 and the fixing portion is fixed at the side opposite to the light emitting side of the emitting surface 21a. The light guide plate 30 and the FPC 10 are fixed by the double-faced tape 40. In this manner, the illuminating apparatus 1 with uniform brightness is produced.

### Second Embodiment

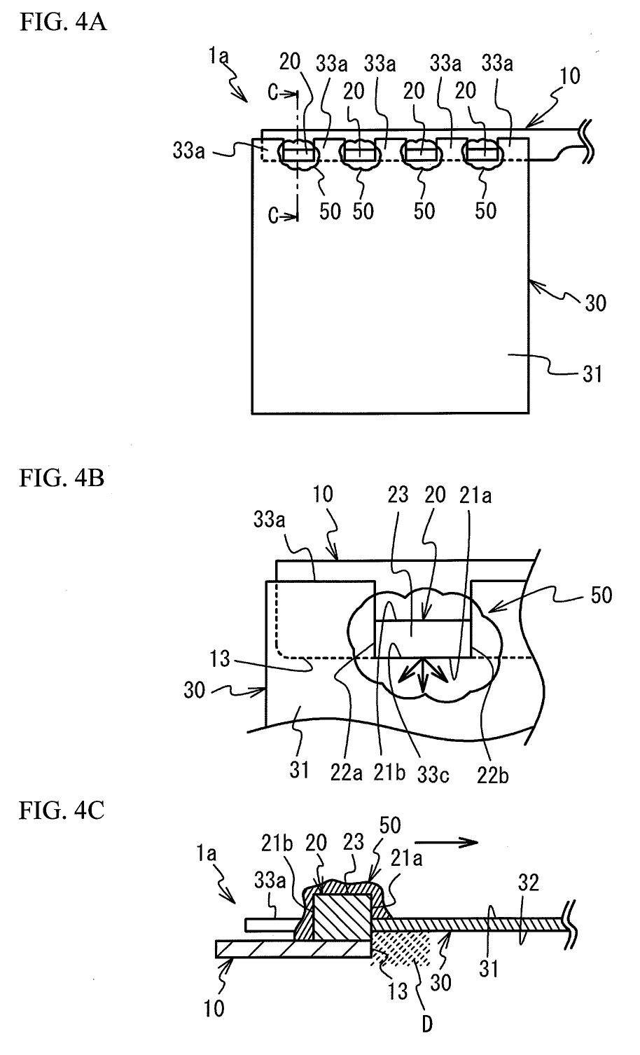

Next, a description will be given of an illuminating apparatus 1a according to a second embodiment. FIG. 4A is a front view of the illuminating apparatus 1a according to the second embodiment. FIG. 4B is an enlarged view of the illuminating apparatus 1a according to the second embodiment. FIG. 4C is a cross-sectional view of the illuminating apparatus 1a taken along a line C-C. Additionally, in the illuminating apparatus 1a according to the second embodiment, similar components of the illuminating apparatus 1 according to the first embodiment depict similar numerals to omit duplicate explanation.

Referring now to FIGS. 4A to 4C, the LEDs 20 are mounted on the FPC 10 along the edge portion 13 at given regular intervals such that the light emitting directions of the LEDs 20, perpendicular to the longitudinal direction of the FPC 10, are aligned side by side. Like the first embodiment, the side, of the light guide plate 30, facing the LEDs 20, is formed into a projection and depression shape to alternately have the projection portion 33a and the depression portion 33b accommodating the LED 20. Herein, the vicinity of the LED 20 serving as the light source is sealed with a sealing material 50. That is, the light guide plate 30 and the LED 20 are fixed at the boundary between the depression portion 33b and the LED 20. Namely, the boundary between the light guide plate 30 and the LED 20 are sealed with the sealing material 50. The sealing material 50 is made of a room temperature cure resin in black. The sealing material 50 seals to cover the range from the emitting surface 31 side of the light guide plate 30 to the boundary between the light guide plate 30 and the LED 20. That is, the light guide plate 30 and the LED 20 are not fixed at a region D located at the light emitting side of the emitting surface 21a of the LED 20 and located at the rear surface 32 side opposite to the emitting surface 31 of the light guide plate 30. Unlike the illuminating apparatus 1 according to the first embodiment, the illuminating apparatus 1a according to the second embodiment dose not use a double-faced tape 40. In the illuminating apparatus 1a, the LED 20 and the light guide plate 30 are directly fixed by the sealing material 50. Further, as illustrated in FIG. 4C, the light guide plate 30 is in contact with a substantial center of the LED 20 in its height direction with being apart from the FPC 10.

In this manner, the light guide plate 30 is directly fixed to the LEDs 20 to be receded from the region D located at the light emitting side of the emitting surface 21a of the LED 20 and located at the rear surface 32 side opposite to the emitting surface 31 of the light guide plate 30. Such a structure eliminates the provision of a member such as a double-faced tape which may influence the light emitted from the light guide plate 30. This prevents the lack of brightness of the light guide plate 30 and also uniforms the brightness.

Additionally, the light guide plate 30 is fixed to the LEDs 20 at the boundary between the depression portion 33b and the LEDs 20. The FPC 10, the LEDs 20, and the light guide plate 30 can be integrated. In this case, the light emitting direction of the FPC 10 can be suppressed from being displaced with respect to the light guide plate 30 in the light emitting direction, like the illuminating apparatus 1 according to the first embodiment.

Further, since a double-faced tape is unnecessary and the FPC 10 dose not have to be directly in contact with the light guide plate 30, the size flexibility of the FPC 10 is improved. That is, the illuminating apparatus 1 according to the first embodiment needs the space for sticking the double-faced tape with respect to the FPC 10, whereas the illuminating apparatus 1a according to the second embodiment eliminates such a space because the light guide plate 30 is directly fixed to the LEDs 20. This reduces the FPC 10 in size.

Also, the light guide plate 30 is fixed at the substantial center of the LED 20 in its height direction as illustrated in FIG. 4C, whereby the light emitted from the LED 20 is effectively guided into the light guide plate 30.

Further, since the boundary between the light guide plate 30 and the LED 20 is sealed with the sealing material 50, the light guide plate 30 is securely fixed to the LED 20. For example, even if the light guide plate 30 is curved, the adhesion between the LED 20 and the light guide plate 30 is maintained.

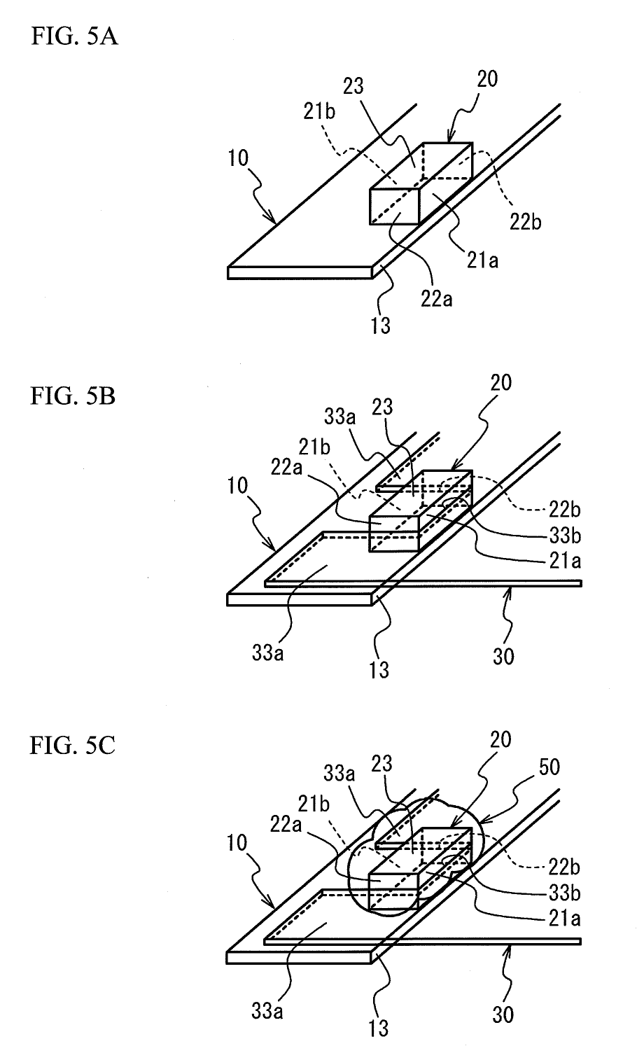

Next, a description will be given of a method for manufacturing the illuminating apparatus 1a according to the second embodiment. FIG. 5A is a partially enlarged perspective view of the FPC 10 with the LED 20 mounted thereon. FIG. 5B is a partially enlarged perspective view of a state where the light guide plate 30 is temporarily fixed to the LED 20. FIG. 5C is a partially enlarged perspective view of a state where the boundary between the LED 20 and the light guide plate 30 is sealed.

First, referring to FIG. 5A, the plural LEDs 20 are mounted along the edge portion 13 of the FPC 10 at give regular intervals such that the light emitting directions of the LEDs 20 are perpendicular to the longitudinal direction of the FPC 10 and are aligned side by side. At this time, the LEDs 20 are mounted such that the emitting surfaces 21a face the outside of the FPC 10. Therefore, the FPC 10 dose not project to the light emitting side of the emitting surface 21a. That is, the FPC 10 projects to the side opposite to the light emitting side of the emitting surface 21a.

Next, an adhesive bond for temporary fixation is applied to the side surfaces 22a and 22b perpendicular to the emitting surface 21a. The adhesive bond for temporary fixation is made of a transparent and colorless ultraviolet cure resin. At this time, the adhesive bond for temporary fixation is not applied to the emitting surface 21a.

Next, as illustrated in FIG. 5, the light guide plate 30 is temporarily fixed to the LED 20 such that the depression portion 33b of the light guide plate 30 faces to be in contact with the emitting surface 21a. Specifically, the light guide plate 30 is supported by a jig such that the depression portion 33b of the light guide plate 30 is positioned at a substantially middle point of the emitting surface 21a in its height direction.

Then, the ultraviolet light is radiated to the side surfaces 22a and 22b to which the adhesive bond for temporary fixation is applied. This temporarily fixes the light guide plate 30 with the LED 20. In this manner, the adhesive bond for temporary fixation is applied to the side surfaces 22a and 22b, thereby fixing the light guide plate 30 with the LEDs 20 at the side opposite to the light emitting side of the emitting surface 21a of the LED 20.

Next, the sealing material 50 is applied to the upper surface 23 of the LED 20, as illustrated in FIG. 5C. Specifically, the sealing material 50 is applied to cover the upper surface 23, the side surfaces 22a and 22b, and the boundary between their vicinities and the light guide plate 30. Then, the sealing material 50 is cured at room temperature. This seals the boundary between the LED 20 and the light guide plate 30 at the emitting surface 31 side of the light guide plate 30 to securely fix the light guide plate 30 to the LED 20.

Herein, as illustrated in FIGS. 5A, 5B, and 4C, in the illuminating apparatus 1a according to the second embodiment, the light guide plate 30 is fixed to the LED 20 at the side opposite to the light emitting side of the emitting surface 21a of the LED 20 by applying the adhesive bond for temporary fixation. Additionally, the boundary between the light guide plate 30 and the LED 20 is sealed with the sealing material 50 at the emitting surface 31 side of the light guide plate 30. That is, the light guide plate 30 and the LED 20 are fixed to be receded from the region D located at the side where the light is emitted form the emitting surface 21a of the LED 20 and located at the rear surface 32 side opposite to the emitting surface 31 of the light guide plate 30. Thus, a member influencing the light emitted from the LED 20 is not present. Therefore, there is no possibility of the following situations. The light, which is entered into the light guide plate 30, is leaked outwardly from the rear surface 32 of the light guide plate 30, thereby reducing the light quantity and lacking the brightness. Additionally, there is no possibility of making the brightness of the emitting surface 31 nonuniform by the diffused reflection within the light guide plate 30. This prevents the lack of brightness of the emitting surface 31 of the light guide plate 30, so uniforms its brightness.

Moreover, the sealing material 50, which is made of the room temperature cure resin in black, fixes the positional relationship between the emitting surface 21a of the LED 20 and the emitting surface 31 of the light guide plate 30. That is, the light guide plate 30 is securely fixed to the LED 20. For example, even when the light guide plate 30 is curved, the adhesion between the LED 20 and the light guide plate 30 is maintained, thereby suppressing the light emitted direction of the LED 20 from being deviated with respect to the light guide plate 30.

### Third Embodiment

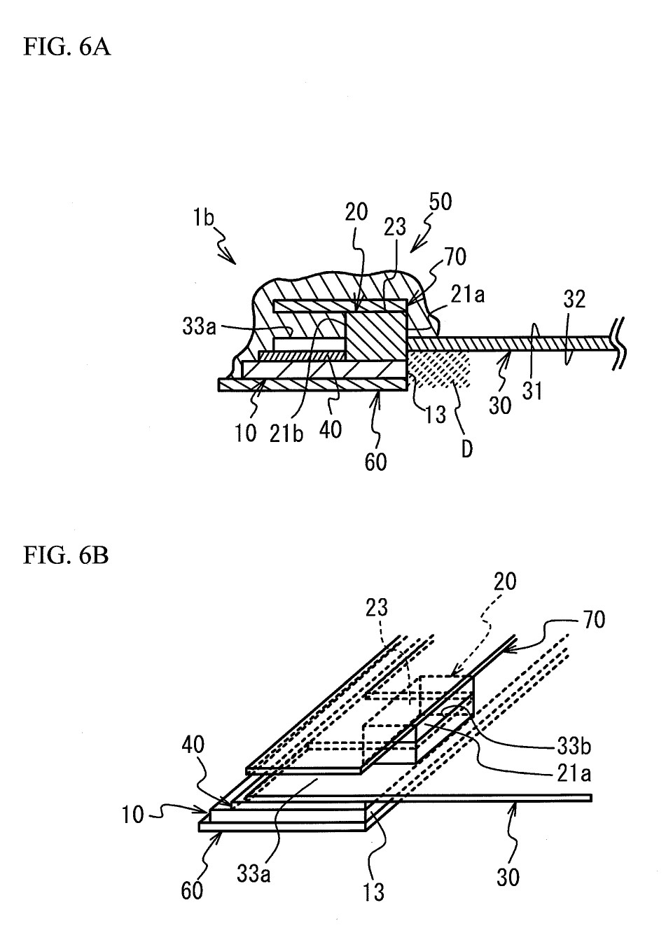

Next, a description will be given of an illuminating apparatus according to a third embodiment. FIG. 6A is a cross-sectional view of an illuminating apparatus 1b according to the third embodiment. In addition, in the illuminating apparatus 1b, similar components of the illuminating apparatus 1 according to the first embodiment are applied to similar reference numerals to omit duplication of description. Further, FIG. 6A corresponds to FIG. 1C.

As illustrated in FIG. 6A, the illuminating apparatus 1b is provided with reflective sheets 60 and 70 each serving as a reflective material. The reflective sheet 60 is stuck to cover the entire bottom surface of the FPC 10, whereas the reflective sheet 70 is stuck to cover the upper surfaces 23 of the plural LEDs 20. Each of the reflective sheets 60 and 70 is formed into a single sheet shape. In this manner, the reflective sheet 70 is provided on the upper surfaces 23 of the plural LEDs 20 so as to cover the plural LEDs 20, thereby effectively utilizing the lights emitted from the LEDs 20 and improving the brightness of the light emitted from the light guide plate 30. Further, the reflective sheet 60 covers the bottom side of the FPC 10, thereby reflecting the light passing through the FPC 10 and further improving the brightness of the light emitted from the light guide plate 30.

Additionally, the reflective sheet 60 is receded from the region D, as illustrated in FIG. 6A. If the reflective sheet 60 extends to the region D, the emitting light emitted from the emitting surface 21a of the LED 20 may be reflected on the reflective sheet 60 at the rear surface 32 side of the light guide plate 30. This may not make uniform the brightness of the light emitted from the light guide plate 30. However, the reflective sheet 60 is receded from the region D, whereby the brightness of the emitting light emitted from the light guide plate 30 can be made uniform.

Also, the reflective sheets 60 and 70 and the LED 20 are sealed with the sealing material 50, as illustrated in FIG. 6A. Therefore, the reflective sheets 60 and 70, and the LEDs 20 are integrated. This prevents the reflective sheets 60 and 70 from peeling from the LED 20, and also suppresses the reflective sheets 60 and 70 from being displaced with respect to the LED 20.

Next, a description will be given of a method for manufacturing the illuminating apparatus 1b. By using the adhesive bond, the reflective sheet 60 is stuck on a bottom side of the FPC 10 with the LED 20 mounted thereon, that is, on a surface opposite to the mounting surface on which the LED 20 is mounted. Next, the double-faced tape 40 is stuck on the mounting surface of the FPC 10, and the light guide plate 30 is fixed by the double-faced tape 40. Then, the reflective sheet 70 is stuck on the upper surfaces 23 of the plural LEDs 20 with an adhesive bond. FIG. 6B is a partially enlarged perspective view of the state in which the reflective sheet 70 is struck on the upper surface 23 of the LED 20. Next, the reflective sheets 60 and 70, the LEDs 20, the projection portion 33a, the periphery of the double-faced tape 40 are sealed with the sealing material 50. This prevents the reflective sheets 60 and 70 from being displaced with respect to the LED 20. Further, the FPC 10, the LEDs 20, the light guide plate 30, and the reflective sheets 60 and 70 are integrated.

### Fourth Embodiment

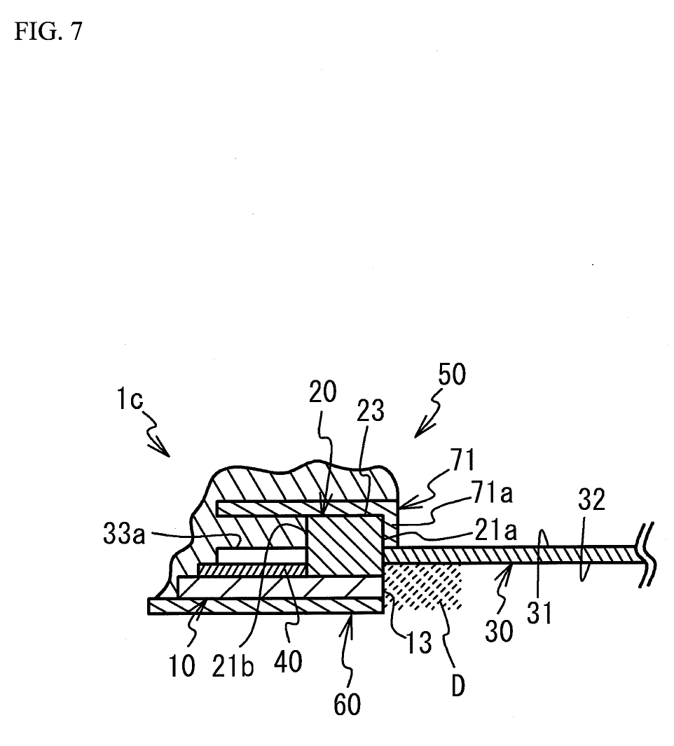

Next, a description will be given of an illuminating apparatus according to a fourth embodiment. FIG. 7 is a cross-sectional view of an illuminating apparatus 1c according to the fourth embodiment. In addition, in the illuminating apparatus 1c according to the fourth embodiment, similar numerals depict similar components of the illuminating apparatus 1b according to the third embodiment, in order to omit duplication description. Additionally, FIG. 7 corresponds to FIG. 6A.

As illustrated in FIG. 7, a reflective sheet 71 covers the emitting surface 21a of the LED 20 at the emitting surface 31 side of the light guide plate 30 in addition to the upper surface 23 of the LED 20. The reflective sheet 71 is formed into a single sheet shape, like the reflective sheet 70 according to the third embodiment, whereas an end portion 71a is bent along the emitting surface 21a and the upper surface 23. In this manner, the reflective sheet 71 provided in the LED 20 covers the emitting surface 21a of the LED 20 at the emitting surface 31 side of the light guide plate 30 in addition to the upper surface 23. This effectively utilizes the light emitted from the LED 20 and further improves the brightness of the light emitted from the light guide plate 30.

Next, a description will be given of a method for manufacturing the illuminating apparatus 1c. In the similar manner as above described in the illuminating apparatus 1b according to the third embodiment, the reflective sheet 60 is stuck on the FPC 10 with the LED 20 mounted thereon to fix the light guide plate 30. Next, an adhesive bond is applied to the emitting surface 21a of the LED 20 at the emitting surface 31 side of the light guide plate 30. Then, the adhesive bond is applied on the upper surface 23. Additionally, the adhesive bond is applied to the plural LEDs 20. Next, the reflective sheet 71 is stuck on the emitting surface 21a with an edge portion of the reflective sheet 71 being in contact with the emitting surface 31 of the light guide plate 30. Next, the reflective sheet 71 is bent to be stuck on the upper surface 23. In this manner, the upper surface 23 and the emitting surface 21a at the emitting surface 31 side of the light guide plate 30 can be covered with the single reflective sheet 71. Additionally, like the illuminating apparatus 1b according to the third embodiment, the FPC 10, the LEDs 20, the light guide plate 30, and the reflective sheets 60 and 71 are integrated with the sealing material 50 after the reflective sheet 71 is stuck.

While the exemplary embodiments of the present invention have been illustrated in detail, the present invention is not limited to the above-mentioned embodiments, and other embodiments, variations and modifications may be made without departing from the scope of the present invention.

In the above embodiments, although the LED is employed as a light source, for example, an organic EL element, a cold-cathode tube, a hot-cathode tube or the like may be employed. Further, the above embodiments exemplify the plural LEDs mounted on the FPC, whereas a single LED may be mounted.

In the above embodiment, the FPC is employed as a substrate, while a rigid substrate other than a FPC may be employed. In addition, the FPC 10 is arranged parallel to the light guide plate 30, whereas the FPC 10 may be arranged perpendicular to the light guide plate 30.

The first embodiment exemplifies the LEDs 20 which are mounted on the FPC 10 at its inner side slightly apart from the edge portion 13 of the FPC 10. However, as described in the second embodiment, the LEDs 20 may be mounted on the FPC 10 along the edge portion 13, and the FPC 10 may project to the side opposite to the light emitting side of the emitting surface 21a.

Further, as described in the second embodiment, even when the LEDs 20 are mounted on the FPC 10 at its inner side slightly apart from the edge portion 13 of the FPC 10 and the FPC 10 projects to the light emitting side of the emitting surface 21a, similar effect can be obtained, as far as the FPC 10 and the light guide plate 30 are not fixed at the region located at the rear surface 32 side of the light guide plate 30 and at the light emitting side of the emitting surface 21a.

In the second embodiment, although the adhesive bond for temporary fixation employs the ultraviolet cure resin, the present invention is not limited to this. Additionally, although the sealing material 50 employs the room temperature curable resin, the present invention is not limited to this.

Finally, several aspects of the present invention are summarized as follows.

According to a first aspect of the present invention, there is provided an illuminating apparatus including: a light source; and a light guide plate guiding a light of the light source. The light source and the light guide plate are fixed to each other to be receded from a region which is a light emitting side of a light emitting surface of the light source and which is opposite to an emitting surface of the light guide plate.

With such a configuration, the light source and the light guide plate are fixed to be receded from the region to which the light is emitted from the light emitting surface of the light source and which is opposite to the emitting surface of the light guide plate. That is, the fixing portion of the light source and the light guide plate is not provided at a rear surface side which is opposite to the emitting surface of the light guide plate and to which the light is emitted from the light emitting surface. Therefore, the light emitted from the light source is not leaked outwardly from the rear surface opposite to the emitting surface of the light guide plate through an adhesive bond or the like. This restricts the influence of the adhesive bond or the like on the light emitted from the light guide plate to prevent the lack of its brightness. This also uniforms its brightness. Further, since the light source and the fixing portion of the light guide plate are fixed by the adhesive bond or the like, the light source and the light guide plate can be integrated. Thus, the light emitting direction of the light source can be prevented from being deviated with respect to the light guide plate.

In the above configuration, the light guide plate may be formed with a depression portion for accommodating the light source, and the light guide plate and the light source may be fixed at a boundary between the depression portion and the light source.

Such a configuration also prevents the lack of brightness of the light emitted from the light guide plate, and uniforms the brightness. Further, since the depression portion of the light guide plate is fixed to the light source at the boundary between the light guide plate and the light source, the light source and the light guide plate can be integrated. This suppresses the light emitting direction of the light source from being deviated with respect to the light guide plate.

In the above configuration, the boundary between the light guide plate and the light source may be sealed with a sealing material. This securely fixes the light guide plate to the light source. Therefore, the light emitting direction of the light source can be suppressed from being deviated with respect to the light guide plate.

In the above configuration, the light guide plate may be in contact with a middle point of the light emitting surface in its height direction. This effectively guides the light emitted from the light source.

In the above configuration, the depression portion may be an alignment portion to have a shape corresponding to an outer shape of the light source. This suppresses the light emitting direction of the light source from being deviated with respect to the light guide plate. An edge portion of the light guide plate has a projection and depression shape with a short distance, thereby suppressing a burr on a surface facing the emitting surface of the LED in a process for forming the light guide plate, and so obtaining the finely surface accuracy. Accordingly, when the light guide plate is arranged at the light emitting surface side of the light source, the entrance of light into the light guide plate is not interfered.

In the above configuration, the light source may include a plurality of light sources mounted on a substrate; and the alignment portion has a shape corresponding to the outer shapes of the plurality of light sources. This suppresses the light emitting directions of the plural light source from being deviated with respect to the light guide plate.

In the above configuration, a reflective material may be provided in the light source, may partially cover the light source, and may be receded from the region. By using the reflective material provided in the light source, the brightness of the light emitted from the light guide plate is improved. Further, the reflective material is receded from the region in which the light is emitted from the light emitting surface of the light source and which is opposite to the emitting surface of the light guide plate, thereby making uniform the brightness of the light emitted from the light guide blade.

In the above configuration, the reflective material and the light source may be sealed with a sealing material. This allows the reflective material and the light source to be integrated, and prevents the reflective material from peeling from the light source. This also suppresses the reflective material from being displaced with respect to the light source.

In the above configuration, the reflective material may cover the light emitting surface, of the light source, on the emitting surface side of the light guide plate. This improves the brightness.

According to a second aspect of the present invention, there is provided an illuminating apparatus including: a substrate; a light source mounted on the substrate; and a light guide plate having a fixing portion and a light guide portion guiding a light emitted from the light source. The light guide plate allows the light guide portion to face a light emitting surface of the light source at a side to which the light is emitted from the light emitting surface, and the fixing portion is fixed to the substrate or the light source at a side opposite to the side to which the light is emitted from the light emitting surface.

With such a configuration, the light guide portion of the light guide plate faces the light emitting side of the light emitting surface of the light source, and the fixing portion of the light guide plate is fixed to the substrate or the light source at the side opposite to the light emitting side of the light emitting surface of the light source. Therefore, the fixing portion is not provided at the light emitting side of the light emitting surface of the light source. Therefore, the light emitted from the light source is not leaked outwardly from the rear surface opposite to the emitting surface of the light guide plate through a double-faced tape or an adhesive bond. This restricts the influence of the double-faced tape or the like on the light emitted from the light guide plate to prevent the lack of its brightness. This also makes its brightness uniform. Further, since the light source and the fixing portion of the light guide plate are fixed by the double-faced tape or the like, the light source and the light guide plate can be integrated. Thus, the light emitting direction of the light source can be suppressed from being deviated with respect to the light guide plate.

According to a third aspect of the present invention, there is provided a method for manufacturing an illuminating apparatus, the method including: mounting a light source on a substrate; fixing a light guide plate to the light source at a side opposite to a light emitting side of a light emitting surface of the light source such that the light emitting surface of the light source faces the light guide plate guiding the light emitted from the light source; and sealing a boundary between the light guide plate and the light source at a emitting surface side of the light guide plate by use of a sealing material.

Such a configuration also prevents the lack of brightness of the light emitted from the light guide plate, and makes its brightness uniform. Further, the light emitting direction of the light source can be suppressed from being deviated with respect to the light guide plate.

In the above configuration, the method may include sealing a boundary between the light guide plate and the light source by means of a sealing material. This securely fixes the light guide plate to the light source, thereby suppressing the light emitting direction of the light source from being deviated with respect to the light guide plate.

In the above configuration, the method may include sealing a reflective material and the light source by means of a sealing material. This allows the reflective material and the light source to be integrated, and prevents the reflective material from peeling from the light source. Further, the reflective material can be suppressed from being displaced.

What is claimed is:

1. An illuminating apparatus comprising:
a light source; and
a light guide plate guiding a light of the light source,
wherein the light source and the light guide plate are fixed to each other to be receded from a region which is a light emitting side of a light emitting surface of the light source and which is opposite to an emitting surface of the light guide plate.

2. The illuminating apparatus of claim 1, wherein
the light guide plate is formed with a depression portion for accommodating the light source, and
the light guide plate and the light source are fixed at a boundary between the depression portion and the light source.

3. The illuminating apparatus of claim 1, wherein the boundary between the light guide plate and the light source is sealed with a sealing material.

4. The illuminating apparatus of claim 1, wherein the light guide plate is in contact with a middle point of the light emitting surface in its height direction.

5. The illuminating apparatus of claim 1, wherein the depression portion is an alignment portion to have a shape corresponding to an outer shape of the light source.

6. The illuminating apparatus of claim 5, wherein
the light source includes a plurality of light sources mounted on a substrate, and
the alignment portion has a shape corresponding to the outer shapes of the plurality of light sources.

7. The illuminating apparatus of claim 1, further comprising a reflective material provided in the light source, partially covering the light source, and receded from the region.

8. The illuminating apparatus of claim 7, wherein the reflective material and the light source are sealed with a sealing material.

9. The illuminating apparatus of claim 7, wherein the reflective material covers the light emitting surface, of the light source, on the emitting surface side of the light guide plate.

10. An illuminating apparatus comprising:
a substrate;
a light source mounted on the substrate; and
a light guide plate having a fixing portion and guiding a light emitted from the light source,
wherein the light guide plate allows the light guide portion to face a light emitting surface of the light source at a side to which the light is emitted from the light emitting surface, and
the fixing portion is fixed to the substrate or the light source at a side opposite to the side to which the light is emitted from the light emitting surface.

11. A method for manufacturing an illuminating apparatus, the method comprising:
mounting a light source on a substrate;
fixing a light guide plate to the light source at a side opposite to a light emitting side of a light emitting surface of the light source such that the light emitting surface of the light source faces the light guide plate guiding the light emitted from the light source; and
sealing a boundary between the light guide plate and the light source at a emitting surface side of the light guide plate by use of a sealing material.

12. The method for manufacturing an illuminating apparatus of claim 11, further comprising sealing a boundary between the light guide plate and the light source by means of a sealing material.

13. The method for manufacturing an illuminating apparatus of claim 11, further comprising sealing a reflective material and the light source by means of a sealing material.
